(19) United States
(12) Patent Application Publication
(10) Pub. No.: US 2011/0202360 A1
(43) Pub. Date: Aug. 18, 2011

(54) SUPPLIER ENROLLMENT PROGRAM

(76) Inventor: Linda McGee, Newark, CA (US)

(21) Appl. No.: 13/004,375

(22) Filed: Jan. 11, 2011

Related U.S. Application Data
(60) Provisional application No. 61/305,829, filed on Feb. 18, 2010.

(51) Int. Cl. G06Q 30/00

(52) U.S. Cl. 705/1.1

(57) ABSTRACT

Methods and systems are presented for a supplier enrollment program in which suppliers who are not enrolled in a payment processing network such as Visa are aggregated, commercial data about them is obtained and appended to the data, and the resulting sales leads are distributed to acquirers. If the acquirer fails to sign up the supplier within a predetermined time limit, then the sales lead is pulled back from the acquirer and rotated to another acquirer to let the other acquirer attempt to sign up the supplier.

### CROSS-REFERENCES TO RELATED APPLICATIONS

This application claims the benefit of U.S. Provisional Application No. 61/305,829, filed Feb. 18, 2010, hereby incorporated by reference in its entirety for all purposes.

### BACKGROUND

1. Field of the Art

Systems and methods are disclosed for uncovering and pursuing sales leads for a payment processing network or system, such as the Visa payment processing network. Specifically, compiling a list of suppliers who do not accept payments through the particular payment processing network, adding publically and privately available commercial information for each supplier to the list, distributing sales leads to acquirers (e.g. banks), and rotating the sales leads to different acquirers are disclosed.

2. Discussion of the Related Art

A company often purchases goods and services from many suppliers. The goods and services that are purchased include everything from office supplies to raw materials to finished deliverable items. Large companies often deal with hundreds or thousands of suppliers.

A “supplier” can be a sole proprietor, partnership, corporation, non-profit organization, government agency, or other entity that supplies goods, services, information, or other things of value to a business.

Businesses often pay their suppliers by cash or check, cutting a check every month, fiscal quarter, etc. for each of its suppliers. However, there is a growing trend to pay suppliers using payment processing networks, such as that offered by Visa. Advantages for the paying company to use a payment processing network to pay its suppliers are plenty. There is generally less risk using a payment processing network than paying in cash, and the printing, issuing, and tracking of paper checks is avoided. A payment processing network conveniently tracks and summarizes each transaction as well as off-loads some of the risk of transacting directly with the other party.

Many companies would preferably pay all of their suppliers through a payment processing network. This would allow them to avoid the use of cash or checks and better track their expenses. All of a company's different expenses for raw materials, office supplies, etc. could be tracked, or double-checked, against the payment processing network's accounting systems. Modern payment processing networks have web-accessible accounts that are available twenty-four hours a day and offer downloadable spreadsheets for automated analysis.

Many suppliers are not enrolled in payment processing systems. They may not be enrolled because of the perceived expense of accepting payments through such systems. They may also not be enrolled because they do not have a retail outlet that is subject to the expectations of the general public to accept credit, debit, prepaid, or other payment cards that are branded by payment processing networks. Many suppliers may be so small or new that they have not sought out signing up for a payment processing network or simply have been overlooked by banks or other acquirers that sell access to payment processing networks.

Rather than investigate which of its suppliers accept what payment processing networks, if any, a company faced with a slew of supplier invoices at the end of the month may sometimes try to pay all of its suppliers through a payment processing network. It may give a list of its suppliers to its bank to determine how to pay. The company's bank, commonly an issuer of business' payment card account, enters each supplier's information into the payment processing network. Suppliers whose information does not match that of any supplier in the payment processing system are noted. The issuer ends up with a list of suppliers who are not enrolled in the payment processing network.

Issuers (e.g. a bank that issues a Visa card) often do not share that information with acquirers (e.g. a bank that signs up a business to accept Visa payment), even when the acquirer is the same bank as the issuer. This can result in a loss of sales opportunities for the acquirers and the payment processing network. This also can frustrate the intentions of companies who wish to pay all (or most) of their suppliers through a payment processing network. The suppliers who do not accept a payment processing card are not identified by those (e.g., acquirers) with the sales ability to educate them about the cost savings and other advantages that accepting payments through a payment processing network can offer.

Embodiments of the invention address these and other problems individually and collectively.

### BRIEF SUMMARY

Embodiments in accordance with disclosures herein generally relate to supplier enrollment programs in which suppliers, who are not enrolled in a payment processing network, are considered and commercial information about them is obtained to create sales leads which are distributed to acquirers. If the acquirer does not make progress with the leads, such as by signing up the supplier with the payment processing network, then the sales lead is pulled back from the acquirer and rotated to another acquirer to let the other acquirer attempt to sign up the supplier.

An embodiment of the present disclosure relates to a method of allocating sales leads to acquirers. The method comprises receiving a list of suppliers that do not currently accept payments through a payment processing service, associating with each supplier in the list of suppliers commercial information about each supplier to generate a sales lead for each supplier, allowing access by an acquirer to the sales lead for each supplier, and removing the acquirer's access to the sales lead and rotating the sales lead to a different acquirer after a preselected time limit after which the supplier still does not accept payments through the payment processing service.

Systems used to enable such a program, such as a supplier enrollment program, are disclosed.

Other embodiments relate to machine-readable tangible media embodying information indicative of instructions for performing the above operations as well as computer systems executing the instructions to perform the operations.

A further understanding of the nature and the advantages of the embodiments disclosed and suggested herein may be realized by reference to the remaining portions of the specification and the attached drawings.

### BRIEF DESCRIPTION OF THE DRAWINGS

FIG. 1 illustrates a supplier enrollment program in accordance with an embodiment.

FIG. 2 is a flow diagram of a supplier enrollment program in accordance with an embodiment.

FIG. 3 illustrates a supplier records page of a supplier enrollment program in accordance with an embodiment.

FIG. 4 illustrates a supplier detail page of a supplier enrollment program in accordance with an embodiment.

FIG. 5 illustrates processing of a list of suppliers in accordance with an embodiment.

FIG. 6 illustrates variable time limit scheme in accordance with an embodiment.

FIG. 7 illustrates a portion of a file detail report of a supplier enrollment program in accordance with an embodiment.

FIG. 8 illustrates an acquirer status page of a supplier enrollment program in accordance with an embodiment.

FIG. 9 is a flowchart illustrating a process in accordance with an embodiment.

FIG. 10 shows a block diagram of an exemplary computer apparatus.

The figures will now be used to illustrate different embodiments in accordance with the invention. The figures are specific examples of embodiments and should not be interpreted as limiting embodiments, but rather exemplary forms and procedures.

### DETAILED DESCRIPTION

Methods and systems of the present disclosure relate to a supplier enrollment program that determines whether suppliers of a business's raw materials, office supplies, etc. accepts payments of its invoices through a payment processing system, such as Visa. A subset of the suppliers is put in a list, and commercial data on the suppliers, such as its headquarters contact information, size of the company, number of employees, yearly revenues, etc., are compiled and associated with each respective supplier on the list. An acquirer (e.g., a bank) is given access through a web page connected with the supplier enrollment program to information on the supplier, a sales lead. The acquirer has a period of time in which to pursue the sales lead by signing the supplier up for the payment processing network/system. If the acquirer fails to sign up the supplier after a certain amount of time, then access to the sales lead is shut off in the web page. The sales lead is then transferred or otherwise rotated to another acquirer so that the new acquirer has a chance to pursue the sales lead. The rotation of the sales lead to the other acquirer can be by blocking or otherwise removing access to the sales lead for the first acquirer and granting access to the second acquirer.

The length of time or deadline that the acquirers have to finalize a contract with the supplier can depend on the size of the acquirer and/or the size of the supplier. Larger suppliers may be more bureaucratic and take more time to coax into using a payment processing system. Smaller suppliers may be more nimble and likely to change sooner to sales pressure, especially if predictions of cost advantages are well supported. Larger acquirers may have larger sales teams that would be expected to sell services to businesses faster. Smaller acquirers may have limited bandwidth to take on new contacts and business challenges.

Supplier Enrollment Program Overview

One embodiment of the present disclosure, a Supplier Enrollment Program (SEP), provides a convenient way to coordinate the efforts of financial institutions to increase payment processing network acceptance. The SEP can provide tangible benefits to a card user, such as a business that uses a credit, debit, or other payment card to make purchases. The SEP can benefit the issuer, the acquirer, and the supplier (e.g., a merchant selling goods, services, information) as well.

One aspect of the Supplier Enrollment Program is a web-based application that provides a computer interface for both issuers and acquirers. The application identifies preferred suppliers of companies, companies that are client organizations of issuers, etc. The list of suppliers includes those suppliers that do not accept particular payment processing network payment products. The application further provides a means to manage the distribution and tracking of supplier sales leads to participating acquirers.

In one aspect, a client organization, such as a corporate business or government agency, works with its issuer to prepare a list of its preferred suppliers, and the issuer submits the supplier list to the Supplier Enrollment Program. Using a supplier matching service either within the program or external to it, the suppliers are matched to a merchant profile database (MPD) and other transaction data to determine which suppliers do not accept payments from the payment processing network. The Supplier Enrollment Program can then distribute sales leads to participating acquirers.

The acquirer, or its designated independent sales organization (ISO), an independent third party used by an acquirer for processing of payment card transactions, contacts the suppliers, explains the benefits of accepting payments through the payment processing network, and offers to sign them up. Once a supplier has either signed up or declined, the acquirer/ISO updates the status of the supplier on the SEP web site.

The issuer then can check the status (or is notified by email), and the issuer informs the client organization. The client organization can then pay its future weekly, monthly, quarterly, etc. bills to the supplier through the payment processing network. The client organization can track payments to its supplier using an account supported by the payment processing network and check its own internal accounting against transactions posted in the payment processing network's account.

Issuers, at their option, may designate a primary and secondary acquirer to receive supplier leads provided by their client organizations. For example, an issuer may desire that a related subsidiary be a primary acquirer and that a sister bank in another geographic area be a secondary acquirer. The distribution of supplier leads can be managed through a complex system that takes issuer designations (e.g., primary, secondary) and several other factors into consideration in determining which acquirer will receive the next supplier sales opportunity.

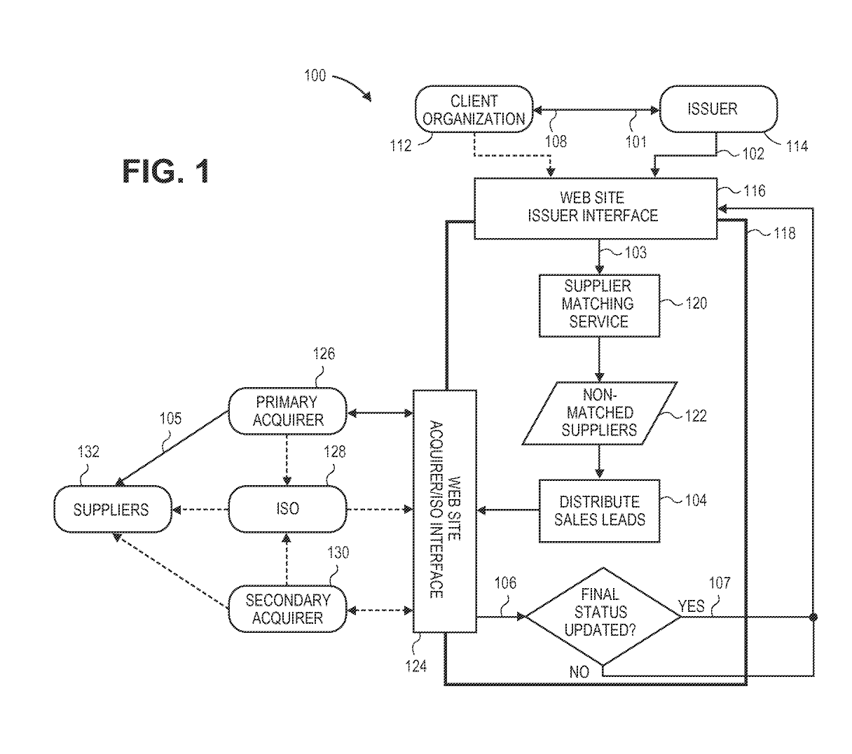

FIG. 1 illustrates a supplier enrollment program in accordance with an embodiment. Supplier enrollment program 100 can include a web-based application that is accessible over the Internet. Each party has its own password-protected user account.

In operation 101 of the figure, client organization 112 prepares a general list of its suppliers and forwards the list to its issuing financial institution 114. Issuing financial institution 114 can be a bank through which client organization 112 holds a credit, debit, or other payment card.

In operation 102, issuer 114 provides the supplier information list to supplier enrollment program web site 118 through web site interface 116, either by uploading a supplier file or by entering (up to five) suppliers manually.

In operation 103, the supplier list is submitted to supplier matching service 120, where it is matched to a merchant profile database (MPD) and a transaction repository to determine which suppliers do not accept payments through the payment processing network. A list 122 of suppliers that do not accept payments through the payment processing network is generated from the general list.

Sales leads are generated from list 122. Commercial information about the suppliers, such as contact information, yearly revenues, number of employees, etc. can be associated with the respective suppliers in list 122. Sales leads are then checked and packaged and readied for distribution.

In operation 104, the web site 118, through acquirer/ISO interface 124, distributes sales leads to participating acquirers by making the sales leads available through interface 124. An acquirer may elect to reassign some or all of its sales leads to an ISO, which may have its own account.

In operation 105, primary acquirer 126 (or its ISO 128) contacts the suppliers, offers to sign them up, and updates the web site with a current status. If acquirer 126 (or its ISO 128) does not update the web site within the specified timeframe, such as 30, 60, or 90 days, then the sales opportunity is withdrawn and the lead is sent to the another acquirer. The sales opportunity can be withdrawn by closing or removing access of the account of primary acquirer 126 to contact information and/or other sales lead information regarding the supplier. The sales opportunity is then “rotated” to another acquirer, such as secondary acquirer 130, so that the other acquirer has a chance to contact the supplier and offer to sign them up. If secondary acquirer 130 does not update the web site with a current status within a predefined time limit, such as 30, 60, or 90 days, then the sales opportunity is withdrawn and the lead is sent to yet another acquirer. The sales opportunity can be passed along from acquirer to acquirer until it is deemed that the supplier is truly not interested in signing up for the card processing service or until the supplier decides to sign up for the service.

In operation 106, once a supplier has either signed or declined, the current acquirer (or its ISO) updates the final status on the web site.

In operation 107, issuer 114 obtains status from the web site 118. For example, issue 118 can be notified by email when a supplier's final status is known.

In operation 108, issuer 114 informs client organization 112 that its supplier has been signed up. This can be via an email, text message, letter, or other messaging means. Further information for an embodiment of the supplier enrollment program is below.

Embodiments of the invention are not limited to the above-described embodiments. For example, although separate functional blocks are shown for an issuer, payment processing network, and acquirer, some entities perform all of these functions and may be included in embodiments of invention.

Issuer Overview

In an initial set-up phase for an issuer in the exemplary embodiment, the issuer will be set up as an approved financial institution in the supplier enrollment program.

The issue can identify one or two contacts within its organization to work with the program. During the initial setup process, the issuer has the option of designating a primary and secondary acquirer (mentioned above) to receive supplier leads provided by its client organizations.

During organization of contact clients, the issuer can identify which of its client organizations are most suitable for the supplier enrollment program and ask them if they wish to participate. Each participating client organization can provide a list of its preferred suppliers. The client organization may also wish to notify suppliers of its intent to give preference to suppliers that accept payments through its issuing bank's payment processing network/system.

In an embodiment, the issuer uploads the client organization's supplier list, an electronic file, to the supplier enrollment program website. Alternatively, the issuer or the client organization may manually enter up to five or more suppliers directly into the SEP website.

The issuer can sign onto the supplier enrollment program web site periodically to monitor the status of the suppliers submitted on the general list. When submitting a supplier list, the issuer has the option to request an email notification each time an individual supplier's status is updated by an acquirer. Reports may be made available to the issuer to print and/or view online. These reports may be forwarded to the client organization if desired.

Once a supplier's status is designated as either “Signed” or “Declined,” it is generally the responsibility of the issuer to notify the client organization. In some embodiments, client organizations do not have authority to monitor supplier status on the supplier enrollment program website.

Acquirer/ISO Overview

In an initial set-up phase of an embodiment for an acquirer or ISO, the acquirer/ISO may need to be set up as an approved financial institution and to identify one or two contact persons within its organization. These contacts can be set up as users on the supplier enrollment program web site. Both primary and secondary contacts can receive an email notification whenever the acquirer/ISO has new supplier records to be downloaded. After downloading a file of new supplier records, the acquirer's/ISO's sales team can contact the suppliers and offer to sign them. Once a supplier has either signed or declined, the acquirer/ISO can log back into the supplier enrollment program web site and update the supplier's status.

The supplier enrollment program of the exemplary embodiment can be used in at least two different ways:

1. If an acquirer/ISO has a relatively small number of suppliers, or does not have a supplier tracking system, the acquirer/ISO may view and manually update the status of suppliers directly on the supplier enrollment program website.

2. If an acquirer/ISO has its own supplier tracking system, it has the option of downloading a supplier file to use in conjunction with its own tracking system. In this case, the acquirer's/ISO's system will update the supplier status in the supplier file and then submit (upload) the updated supplier file to the supplier enrollment program web site.

ISO Considerations

The supplier enrollment program of the exemplary embodiment assigns supplier records only to acquirers; however, an acquirer may elect to assign some or all of its supplier records to an ISO. In this case, an email notification will be sent to the ISO's primary and secondary contacts whenever there are new supplier records to be downloaded. Once the records are downloaded, the ISO will perform the same functions the acquirer would have performed, contacting suppliers and using the supplier enrollment program web site to update the supplier status.

A single ISO may have relationships with multiple acquirers. If an email address is used to log into the supplier enrollment program website, an ISO should have a separate email address for each of its acquirer relationships (e.g., acquirer1@ISO.com, acquirer2@ISO.com).

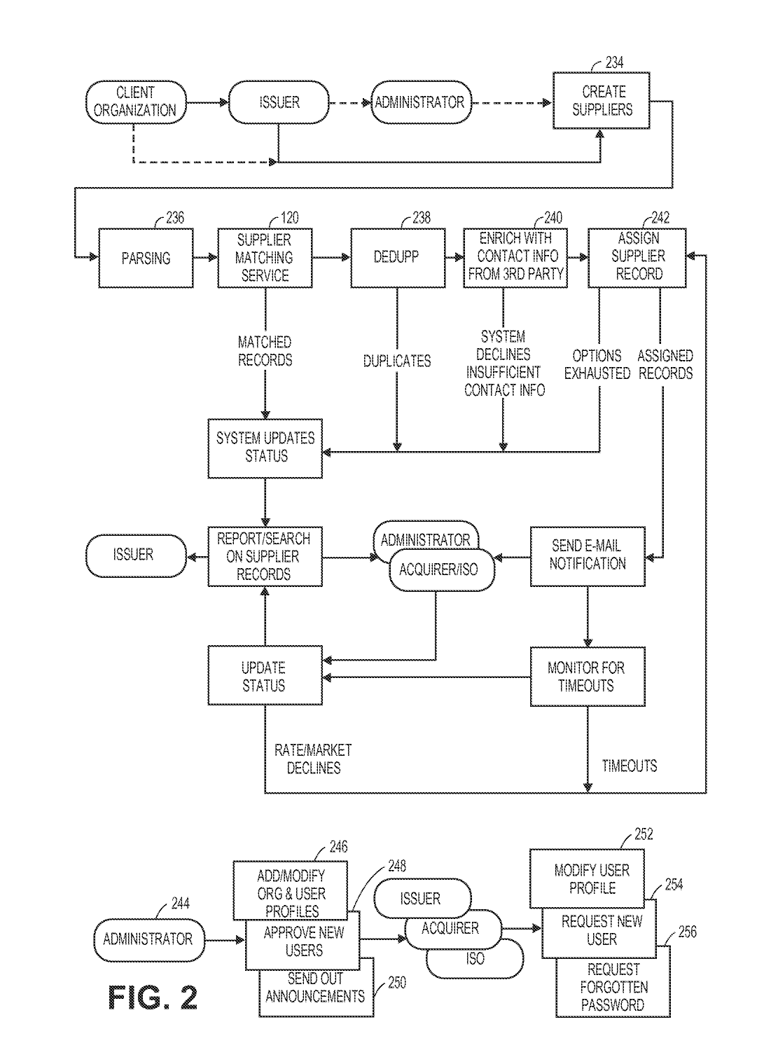

FIG. 2 illustrates a supplier enrollment program process flow in accordance with an embodiment. Supplier records are created in the system in operation 234, parsed in operation 236, and subject to a supplier matching service 120. In operation 238, duplicate list entries are deleted. In operation 240, records are enriched with contact information from a 3rd party, such as a vendor of such information. In operation 242, the sales leads are assigned to acquirers. Timeouts are monitored so that supplier records can be rotated among acquirers/ISOs.

Setting up an Organization Profile

A supplier enrollment program administrator 244 (bottom of figure) can work with each financial institution to set up an organization profile and to specify basic preferences. As part of this process in the exemplary embodiment, the financial institution will designate a primary and optionally a secondary contact. The supplier enrollment program application can automatically build user profiles for the primary and secondary contacts when the Organization Profile is built. An ISO that has relationships with multiple acquirers may require a separate organization profile for each of its acquirer relationships.

Administrator 244 can add/modify organization user profiles in operation 246, approve new users in operation 248, and send out announcements in operation 250. Issuers, acquirers, and ISOs can modify their respective user profiles in operation 252, request new users to be created in operation 254, and request forgotten and/or lost passwords in step 256.

Issuer Preferences

In the organization profile of an embodiment, issuers may designate one or two acquirers (e.g., a primary and a secondary acquirer) to receive any supplier leads provided by its client organizations. For example, an issuer may wish to designate its own acquiring branch or the acquiring branch of an affiliated business unit as the primary acquirer. More acquirers can also be designated as tertiary, quaternary, quinary, etc. acquirers. Supplier leads not sent to a designated acquirer can be distributed to other participating acquirers. The issuer may change its acquirer designations at any time by contacting the supplier enrollment program administrator.

Acquirer and ISO Preferences

In the organization profile of the exemplary embodiment, acquirers and ISOs have the option to exclude suppliers on the basis of specific geographic states and/or Merchant Category Codes (MCCs). In an embodiment, the supplier enrollment program application takes these exclusions into consideration when: a) determining which acquirer will be assigned the next supplier record, or b) an acquirer assigns a supplier record to an ISO. The acquirer/ISO may change these exclusions at any time by contacting the supplier enrollment program administrator.

User Roles

There can be four user roles in the exemplary SEP application:

1. Issuer Role: The role permits the uploading of a file of supplier records or the manual entry of up to five suppliers. It also permits searching for suppliers and viewing issuer reports.

2. Acquirer Role: The role permits the downloading of supplier records, subsequent updating of status for supplier records, and assignment of supplier records to ISOs. It also permits searching for suppliers and viewing acquirer reports.

3. ISO Role: The role permits the downloading of supplier records that have been assigned to the ISO by an acquirer and subsequent updating of status for each supplier record. The role also permits searching for suppliers and viewing ISO reports.

4. SEP Administrator: In the SEP Administrator role, one can perform most of the functions available to client organizations, issuers, acquirers, and ISOs. In addition, the SEP Administrator is able to grant user access, approve supplier records submitted directly by client organizations, and send announcements. Key functionality that is not available to the SEP Administrator include the assignment of supplier records to an ISO, and viewing or downloading acquirer/ISO files.

In the exemplary embodiment, all users belonging to the same financial institution can have the ability to view all supplier records submitted or downloaded by that organization. On reports, acquirers may view statistics for any ISO to whom it has assigned records; however, an ISO generally cannot view statistics for an acquirer.

In order for the SEP Administrator to be able to view the supplier enrollment program application exactly the way that an issuer or acquirer/ISO sees it, the SEP Administrator may need to create a user profile within that financial institution and log on as that user.

File and Record Status

The status displayed for files and supplier records depends on the role of the user in some embodiments.

The SEP Administrator can be able to view files from an issuer's perspective. However, the SEP Administrator may not be able to view or download acquirer/ISO files in some embodiments. At a detailed supplier record level, the SEP Administrator is able to view the assignment history of supplier records.

Issuers can be able to view supplier records after they have been assigned to an acquirer in certain embodiments.

Acquirers and ISOs are able to view supplier records after they have been downloaded in some embodiments. Acquirers are able to view supplier records they have assigned to an ISO, but are not able to update those records. Acquirers and ISOs are generally not able to view supplier records after they have been reassigned or declined for any reason.

Submitting Supplier Records

In the exemplary embodiment, an issuer may upload a file of one or more suppliers in Microsoft Excel or CSV (comma separated variable) formats or, if there are five or fewer suppliers, the issuer may manually enter them into the supplier enrollment program web site.

In the exemplary embodiment, a client organization may manually enter up to five suppliers into the supplier enrollment program website. A user from a client organization does not require a password to access the supplier enrollment program website and does not have a user profile. Generally, all suppliers submitted by client organizations need to be approved by the SEP Administrator. Because client organizations typically have only limited access to the supplier enrollment program website, they cannot upload supplier files or monitor supplier status.

Once an issuer or client organization has submitted a file or list of suppliers to the supplier enrollment program web site, the issuer can monitor supplier status by logging in periodically to the supplier enrollment program web site in some embodiments. Issuers may also elect to be notified by email whenever a supplier is signed (or declined). This option is available on a per file basis.

Supplier Pre-processing

After supplier records have been submitted by an issuer or client organization, the supplier enrollment program application embodiment can perform the following pre-processing of supplier records before assigning them to an acquirer:

1. Parsing: Supplier records can be parsed in operation 236 to determine the name and address fields. The application assigns a supplier record ID to each supplier record.

2. Supplier Matching Service (SMS) Matching: SMS 120 can match the supplier records against the merchant profile database and other databases using supplier enrollment program match rules. These match rules are a subset of the standard SMS match rules and provide for a much tighter match (e.g., no name-only matches).

Polling between the SEP application and the supplier matching service occurs approximately every fifteen minutes in the exemplary embodiment.

Since parsing and the assignment of supplier record IDs are performed prior to SMS matching in the exemplary embodiment, the existing SMS capability of replacing an original file may not work for SEP supplier records. As a precaution against this occurring, a supplier enrollment program may elect to reject any file from SMS that does not contain supplier enrollment program supplier record IDs.

3. Dedupping: Unmatched supplier records are matched against the SEP database in dedupp operation 238 to determine if there are any duplicates. Original supplier records that were system-declined for reason of insufficient contact information are excluded from this process. This allows potentially duplicate supplier records that do contain sufficient contact information to be distributed as valid sales leads.

4. Third Party Matching: Supplier records are matched in operation 240 against third party data (i.e., Acxiom data), and the matched supplier records are enhanced with additional information (e.g., telephone contact information, sales volume, employee count).

5. Managing Contact Information: Any supplier record that does not have both a supplier name and contact phone number can be system-declined for reason of “insufficient contact information” in the embodiment.

Supplier Record Assignment

In the exemplary embodiment, supplier records are assigned in operation 242 to acquirers based on a number of factors, including issuer designation of preferred acquirers, load balancing, and any exclusions by state and/or merchant category codes (MCCs) as specified in the organization profile. The SEP Administrator also has the ability to regulate the flow of suppliers to an acquirer.

If an acquirer does not download a supplier record within the specified timeframe, the lead is reassigned to another acquirer. For example, a timeframe can be a predefined number of days (e.g., 7, 30, 60, 90) or a particular date (e.g. March 31, June 30). If no acquirers were designated by the issuer, supplier leads can be distributed to a participating acquirer based on the size of the acquirer or size of the targeted supplier in a load balancing formula.

The following key terms are helpful in understanding how the load balancing formula works:

Total Pending Suppliers: The number of records currently assigned to an acquirer, whether or not they have been downloaded. Records assigned to an ISO are also included.

ISO Pending Suppliers: The number of records currently assigned to an ISO. This is a subset of Total Pending Suppliers.

Calculated Queue Length: Calculated by dividing Total Pending Suppliers by Current Efficiency Rating. Acquirers with a higher Current Efficiency Rating have a shorter Calculated Queue Length, allowing them to be assigned more records than less efficient acquirers.

Current Efficiency Rating: The percent rating of an acquirer's performance, in which 100% is considered “normal” performance. Values less than 100% are below normal and values greater than 100% are above normal. The SEP Administrator can manually change the value of the Current Efficiency Rating. The value of the rating is used to calculate the relative distribution of supplier records.

Recommended Efficiency Rating: A value generated by the SEP application using an algorithm based on past Acquirer performance. The Recommended Efficiency Rating provides a guideline to the SEP Administrator, who can manually change the value of the Current Efficiency Rating.

Load Balancing

The load balancing formula of the exemplary embodiment uses the Calculated Queue Length to determine which acquirer will receive the next supplier record. Each acquirer is assigned an initial efficiency rating of 100% when the supplier enrollment program is set up. Each acquirer's progress is monitored by the SEP Administrator and the supplier enrollment program business consultant. The efficiency rating is multiplied by the actual number of records currently assigned to the acquirer to determine where the next record will be assigned. The following table is an example of how this works.

| | | Records Assigned | Effective Queue |
|---|---|---|---|
| Acquire Name | Efficiency Rating | to Acquirer | Length |
| Acquirer 1 | 100% | 5 | 5 |
| Acquirer 2 | 70% | 5 | 7.14 |
| Acquirer 3 | 150% | 5 | 3.33 |

In this example, Acquirer 3 has the shortest Calculated Queue Length and will therefore receive the next supplier record available for distribution.

All acquirers can be assigned an initial efficiency rating of 100% in the exemplary embodiment.

Formula for Assigning Acquirers

In the exemplary embodiment, for each supplier record that is ready to be assigned to an acquirer, the following formula can be used:

1. Create a list of all acquirers, sorted by the current value of Calculated Queue Length, from shortest to longest, descending by Current Efficiency, and then ascending by the date that the acquirer was entered into supplier enrollment program.

2. “Boost” preferred acquirers to the beginning of the list.

3. Eliminate any acquirers from the list if they have already had this record assigned to them or if the acquirer is excluded by state or merchant category code.

4. Assign the record to the first remaining acquirer in the list. If no acquirers remain on the list, then the record can be marked as ‘Options Exhausted.’

Supplier Reassignment

In the exemplary embodiment, supplier records that were assigned to an acquirer and were not acted upon within an agreed-upon timeframe can be reassigned to another acquirer based on the formula discussed above. Some of the reasons for reassigning a supplier record are listed below:

1. The acquirer did not download a supplier within ten days of being notified by email.

2. The acquirer (or its ISO) did not update the supplier enrollment web site within fourty-five days of downloading a supplier record. If the sales process is expected to take more than forty-five days to complete, the acquirer/ISO may update the status to “Ongoing” within forty-five days of downloading a supplier. Otherwise, the supplier will be reassigned to another acquirer.

3. The supplier declined the proposed payment processing network product because, for example, the rate was too high.

4. The acquirer/ISO updated the supplier enrollment program web site to reflect that the supplier does not sell to this particular market.

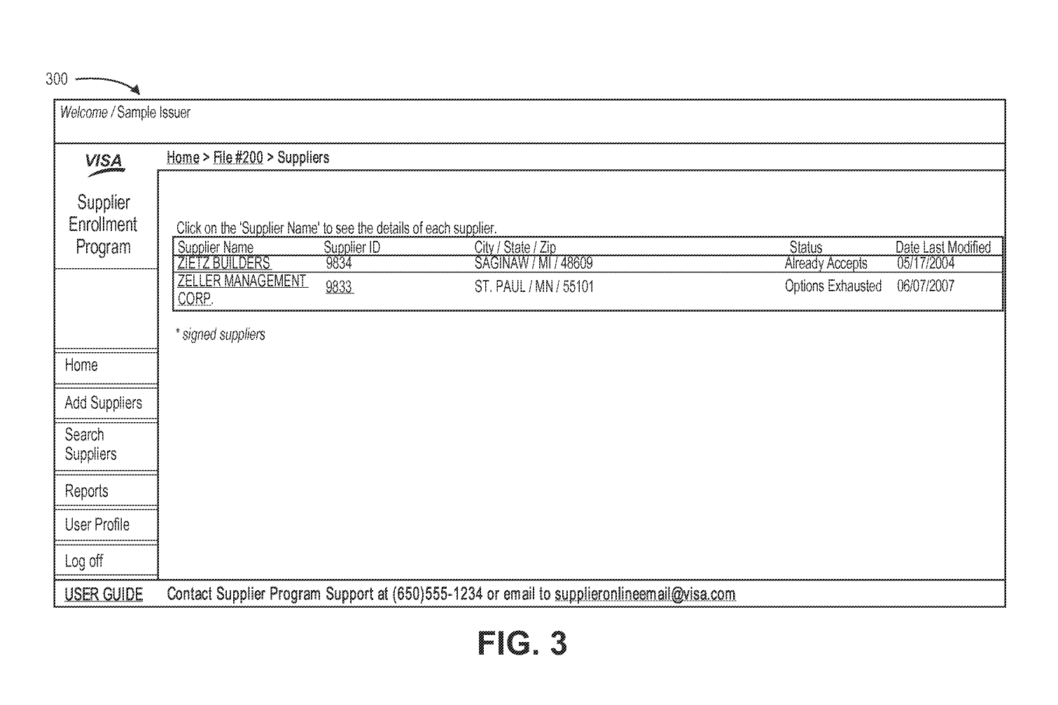

FIG. 3 illustrates a supplier records page of a supplier enrollment program in accordance with an embodiment. The status on the two listed suppliers indicate that one supplier already accepts payments through the payment processing network and that options have been exhausted for signing up the other supplier. An underlined supplier name can be clicked by a user to reveal more detailed information about the supplier.

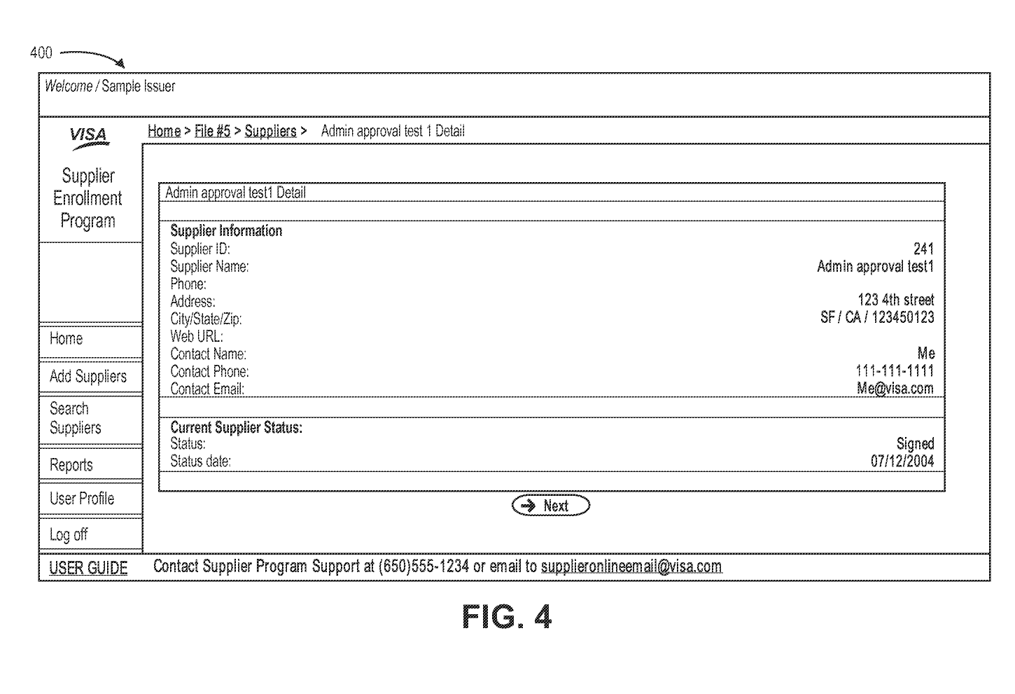

FIG. 4 illustrates a supplier detail page of a supplier enrollment program in accordance with an embodiment. The page can appear after a user has clicked on an underlined supplier name. Contact information for a particular supplier is listed as well as a status of the supplier as a sales lead. Status of the supplier, such as whether the supplier has already signed up to accept payments through the payment processing service, whether the supplier has declined, whether marketing is ongoing or pending, or whether all options have been exhausted to sign up the supplier, are shown at the bottom.

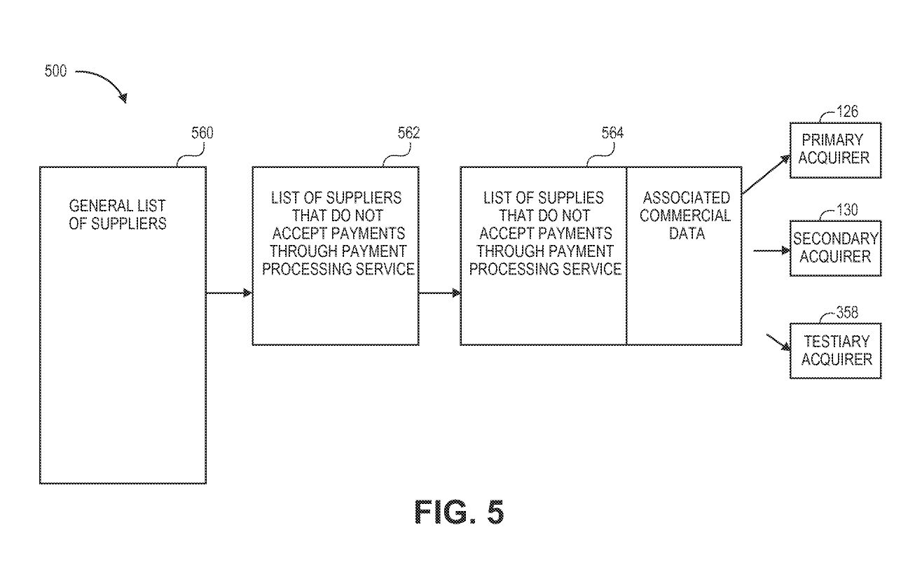

FIG. 5 illustrates processing of a list of suppliers in accordance with an embodiment. General list of suppliers 560 is presented by uploading a file, entering the general list into a web page, or other means. General list of suppliers 560 may be all suppliers that a client organization uses as suppliers of goods, services, information, etc., or can be a subset of all such suppliers. For example, general list of suppliers 560 can be all suppliers that a client organization reasonably believes accept payments through a particular payment processing network. As another example, general list of suppliers 560 can be suppliers whose invoices are due within the next week.

General list of suppliers 560 is culled, through supplier matching service 120 (FIG. 1) into list of suppliers 562 that do not accept payments through the payment processing service. List of suppliers 562 may include suppliers that accept payments through other payment processing networks but not the specified payment processing network. List of suppliers 562 is appended with commercial data, such as D & B data, into list 564. This can be so that a salesman may better understand the task involved in attempting to sign up the supplier to accept payments through the payment processing network.

List 564, or portions thereof, are made available to primary acquirer 126, secondary acquirer 130, and tertiary acquirer 358 at respective timeframes. Each acquirer can have its sales team contact the supplier and attempt to sign them up to accept payments through the payment processing system.

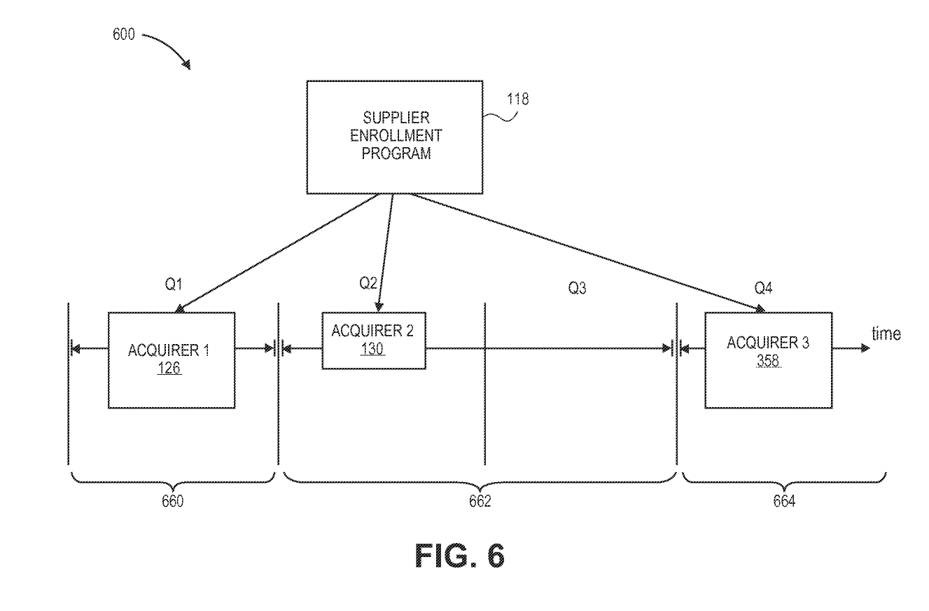

FIG. 6 illustrates variable time limit scheme in accordance with an embodiment. Supplier enrollment program 118 sends information on a supplier to acquirer 126 and gives the acquirer time limit 660, until the end of the first quarter (i.e., March 31) to sign up a supplier for the payment processing network. Because acquirer 126 is large, only one calendar quarter is given for its larger sales team to sign up the supplier. After acquirer 126 is unable to sign up the supplier at the end of the first quarter, supplier enrollment program 118 removes access on its web site for acquirer 126 to track the supplier. Supplier enrollment program 118 then allows access to the supplier to acquirer 130 for time limit 662, which is two quarters in the exemplary embodiment. Acquirer 130 is given two quarters, or until the end of the third quarter (i.e., September 30), to sign up the supplier because it has a smaller sales team than the previous acquirer. After acquirer 130 is unable to sign up the supplier at the end of the third quarter, supplier enrollment program 118 removes access on its web site for acquirer 130 to track the supplier. Supplier enrollment program 118 then allows access to the supplier to acquirer 358 for time limit 664. This time limit may extend past the fourth quarter (i.e., past December 31). After this time limit, it may be deemed by the last acquirer, or supplier enrollment program 118, that all options are exhausted to sign up the supplier.

Although quarters (i.e., Q1, Q2, Q3, Q4) are shown in the exemplary embodiment, one skilled in the art would recognize that other time periods and ending dates are equally applicable.

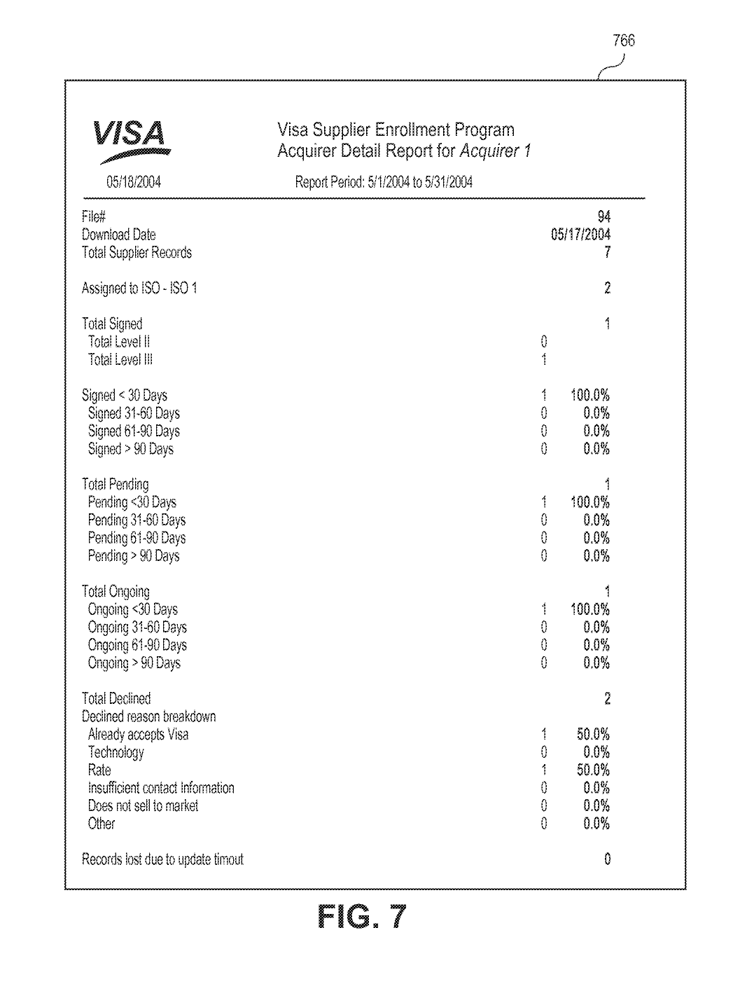

FIG. 7 illustrates a portion of a file detail report of a supplier enrollment program in accordance with an embodiment. One may view and print report 766 online or download it to a local system. Summary reports may be downloaded in PDF format, and detail reports may be downloaded in either PDF or CSV (comma-delimited) format. This can be useful when one wishes to use the report data for additional processing. Reports may be generated for last month, for the current month, or within a user-specified date range.

The exemplary embodiment shows statistics of seven supplier records aggregated by their respective statuses. The seven suppliers are tracked by the system and may be further processed for additional statistics.

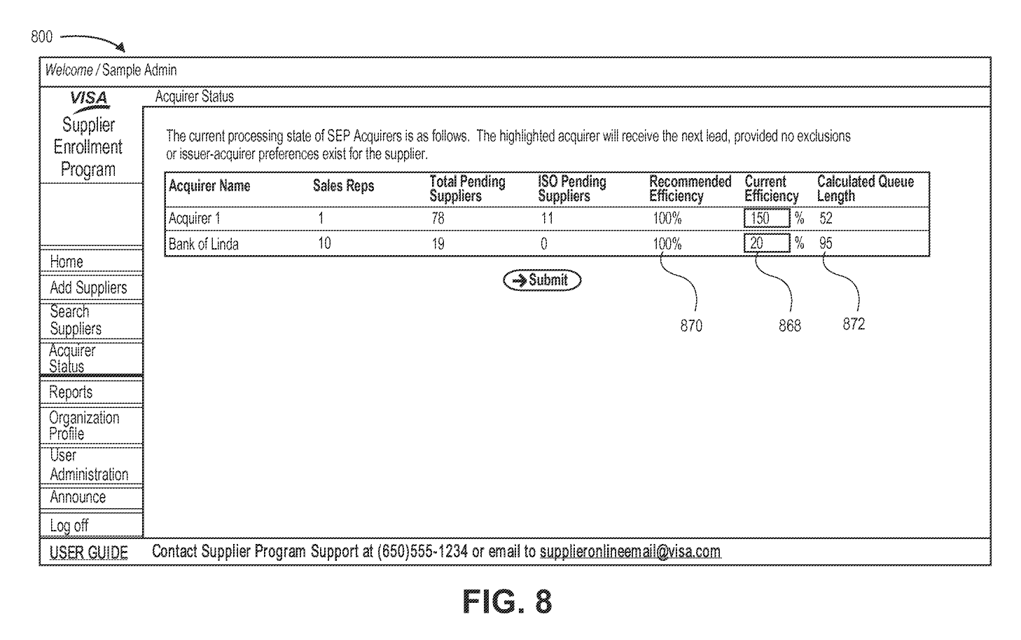

FIG. 8 illustrates an acquirer status page of a supplier enrollment program in accordance with an embodiment. Besides Sales Reps, Total Pending Suppliers, and ISO Pending Suppliers, each Acquirer profile includes:

Recommended Efficiency 870: Displays 100% for all acquirers in the figure. This value can be system-generated from an algorithm based on the acquirer's past performance. This efficiency rating can provide a guideline to the SEP Administrator who will manually enter the actual efficiency rating, which will be used to distribute records.

Current Efficiency 868: This is a measure of the acquirer's performance in handling sales leads. The SEP Administrator manually maintains this value in the acquirer's Organization Profile with feedback from the SEP Business Consultant and agreement with the respective acquirer.

Calculated Queue Length 872: This is the quotient of Total Pending Suppliers divided by Current Efficiency. Acquirers with higher efficiency values generally have shorter effective queues, allowing them to be assigned more records than less efficient acquirers.

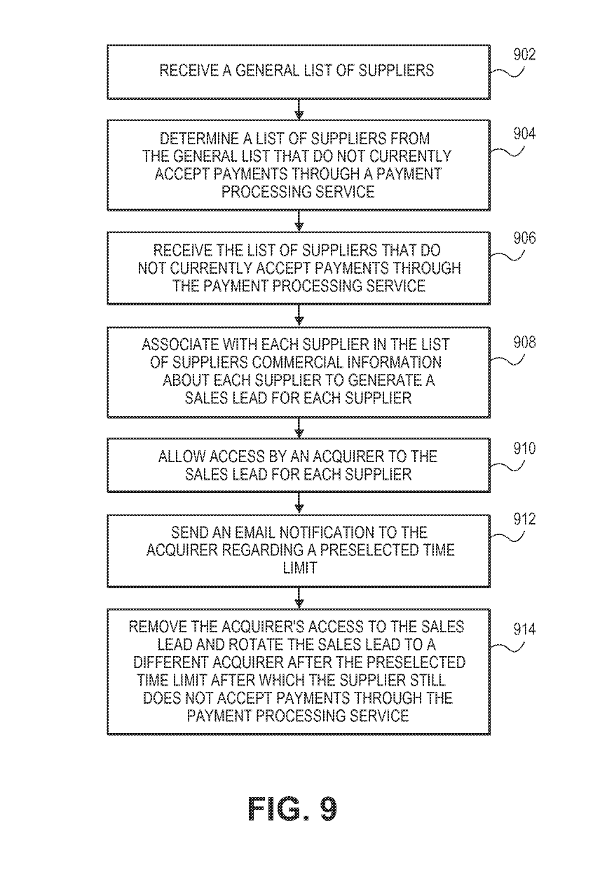

FIG. 9 is a flowchart illustrating a process in accordance with an embodiment. The operations shown in the flowchart and other flowcharts can be performed by a computer with a processor and memory or other machine, and the operations in the flowcharts can be stored as machine-readable instructions and accessed by a processor. In operation 902, a general list of suppliers is received. In operation 904 a list of suppliers that do not currently accept payments through a payment processing service is determined from the general list. In operation 906, the list of suppliers that do not currently accept payments through the payment processing service are received. In operation 908, each supplier in the list of suppliers is associated with commercial information about each respective supplier to generate a sales lead for each supplier. In operation 910, access is allowed by an acquirer to the sales lead for each supplier. In operation 912, an email notification is sent to the acquirer regarding a preselected time limit. In operation 914, the acquirer's access to the sales lead is removed and the sales lead is rotated to a different acquirer after the preselected time limit after which the supplier still does not accept payments through the payment processing service.

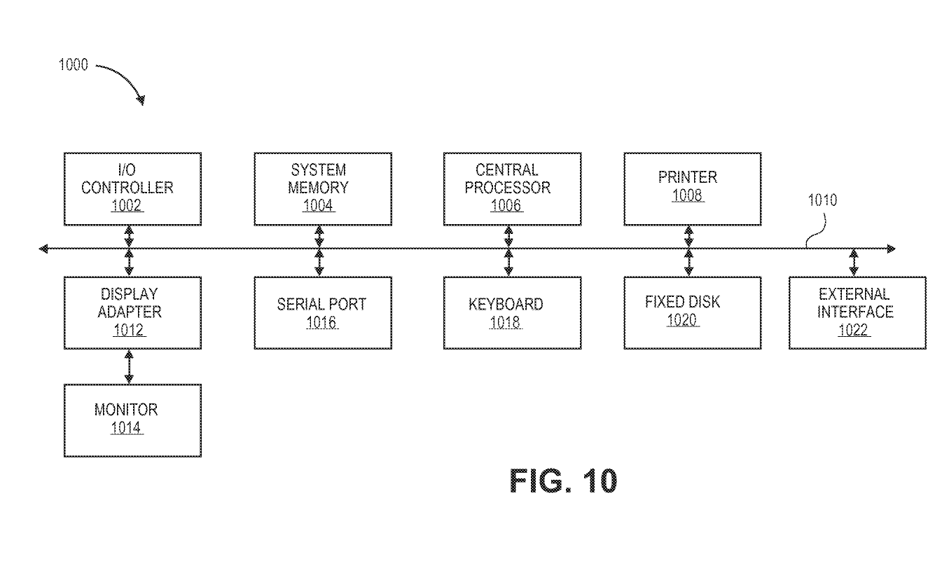

Examples of subsystems or components of such computer apparatuses are shown in FIG. 10. The subsystems shown in the figure are interconnected via a system bus 1010. Additional subsystems such as a printer 1008, keyboard 1018, fixed disk 1020 (or other memory comprising computer readable media), monitor 1014, which is coupled to display adapter 1012, and others are shown. Peripherals and input/output (I/O) devices, which couple to I/O controller 1002, can be connected to the computer system by any number of means known in the art, such as serial port 1016. For example, serial port 1016 or external interface 1022 can be used to connect the computer apparatus to a wide area network such as the Internet, a mouse input device, or a scanner. The interconnection via system bus allows the central processor 1006 to communicate with each subsystem and to control the execution of instructions from system memory 1004 or the fixed disk 1020, as well as the exchange of information between subsystems. The system memory 1004 and/or the fixed disk 1020 may embody a tangible computer readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method of allocating sales leads to acquirers, the method comprising:
receiving a list of suppliers that do not currently accept payments through a payment processing service;
associating with each supplier in the list of suppliers commercial information about each supplier to generate a sales lead for each supplier;
allowing access by an acquirer to the sales lead for each supplier; and
removing, using a processor operatively coupled with a memory, the acquirer's access to the sales lead and rotating the sales lead to a different acquirer after a preselected time limit after which the supplier still does not accept payments through the payment processing service.

2. The method of claim 1 wherein the rotating comprises allowing access by the different acquirer to the sales lead through a web interface.

3. The method of claim 1 wherein the preselected time limit is selected based upon a size of acquirer to which access is allowed to the sales lead.

4. The method of claim 1 wherein the preselected time limit is selected based upon a size of the supplier corresponding to the sales lead.

5. The method of claim 1 wherein the preselected time limit comprises a limit selected from the group consisting of a calendar date, a number of days, and a number of months.

6. The method of claim 1 further comprising:
receiving a general list of suppliers; and
determining a list of suppliers from the general list that do not currently accept payments through the payment processing service.

7. The method of claim 1 further comprising:
sending an email notification to the acquirer allowed access regarding the preselected time limit.

8. The method of claim 1 further comprising:
sending information about the sales lead to the acquirer to whom access is allowed.

9. The method of claim 1 wherein the removing includes denying access privileges for an account of the respective acquirer to information regarding the sales lead.

10. The method of claim 1 wherein the commercial information includes the respective supplier's contact address, sales volume, and number of employees.

11. The method of claim 1 wherein the payment processing service comprises a credit or debit card processing service.

12. The method of claim 1 wherein the operations are performed in the order shown.

13. The method of claim 1 wherein each operation is performed by the computer processor operatively coupled to a memory.

14. A machine-readable storage medium embodying information indicative of instructions for causing one or more machines to perform the operations of claim 1.

15. A computer system executing instructions in a computer program, the computer program instructions comprising program code for performing the operations of claim 1.

16. A machine-readable tangible medium embodying information indicative of instructions for causing one or more machines to perform operations comprising:
receiving a list of suppliers that do not currently accept payments through a payment processing service;
associating with each supplier in the list of suppliers commercial information about each supplier to generate a sales lead for each supplier;
allowing access by an acquirer to the sales lead for each supplier; and
removing, using a processor operatively coupled with a memory, the acquirer's access to the sales lead and rotating the sales lead to a different acquirer after a preselected time limit after which the supplier still does not accept payments through the payment processing service.

17. A computerized system for allocating sales leads to acquirers, the system comprising:
a processor;
a memory operatively coupled with the processor;
a supplier matching service operative to determine a list of suppliers that do not currently accept payments through a payment processing service;
an data gathering service operative to associate each supplier in the list of suppliers with commercial information about each supplier to generate a sales lead for each supplier; and
a sales leads distribution service, executing on the processor, operable to allow access to a sales lead for each supplier to an acquirer and, after a preselected time limit after which the supplier does not accept payments through the payment processing service, remove the acquirer's access to the sales lead and rotate the sales lead data to a different acquirer.
